(19) United States
(12) Patent Application Publication
(10) Pub. No.: US 2025/0136845 A1
(43) Pub. Date: May 1, 2025

(54) TAPE FOR SEALING PACKAGES

(71) Applicants: LANCE KIETH JAMES, Montclair, NJ (US); HOWE CHAN, Taichung City (TW); FAR EASTERN STANDARD PACKAGING CO., LTD., Taichung City (TW)

(72) Inventor: LANCE KIETH JAMES, Montclair, NJ (US)

(21) Appl. No.: 18/499,399

(22) Filed: Nov. 1, 2023

(51) Int. Cl. C09J 7/29; C09J 7/20; C09J 7/38; C09J 11/02

(52) U.S. Cl. CPC C09J 7/29; C09J 7/201; C09J 7/38; C09J 11/02; C09J 2301/122; C09J 2301/16; C09J 2301/408; C09J 2301/41

(57) ABSTRACT

A tape for sealing packages includes a cylindrical body and a tape strip. The tape strip includes a strip body, a release layer, an adhesive layer and two non-adhesive layers; the cylindrical body is in an annulus shape and has a predetermined width; the strip body is transparent and has an inner side and a relative outer side; the release layer is on the outer side of the strip body; the adhesive layer is in a middle section of the inner side; the two non-adhesive layers are on two sides of the adhesive layer on the inner side respectively; the two non-adhesive layers and the adhesive layer so formed are coated with a glue degrader, so that both sides of the adhesive layer lose their adhesiveness to become the non-adhesive layers; the tape strip is wound around the periphery of the cylindrical body to match a package.

### BACKGROUND OF THE DISCLOSURE

### Technical Field

The present disclosure relates to a tape for packaging and sealing a package for shipment, more particularly relates to a tape designed according to the structure of the tape body and the specification of the package.

### Description of the Related Art

In general, tapes are applied to the exterior of a shipping package after loading the goods, and the openings of the package are sealed before shipping, so as to avoid the goods from falling out and prevent others from opening the package arbitrarily. At present, most of the packaging tapes are very long strips having a surface all with adhesive and another surface rolled up without adhesive. In use, the tape is torn off to adhere to the package. After the tape is pulled out to a desired length, a tape dispenser or a cutter may be used to cut the tape for use. Although the use of the tape dispenser for cutting the tape is much more convenient than the use of the cutter, the tape dispenser is large and heavy. It is prone to cause injury to the arms and shoulders of a worker or a user in long-term use of the tape dispenser.

In the current design of the adhesive tape disposed on one side of the tape, it is necessary to have a tool to cut the tape in order to open the package, and it is very difficult to open the package with bare hands, or recycle the package by removing the adhesive tape on the package. Therefore, the present disclosure provides an easy-to-use hand-peeling tape as shown in FIGS. 1 to 3.

The conventional easy-to-use hand-peeling tape includes a cylindrical body 50 and a tape strip 60, the tape strip 60 has a thickness extended outward into a flat shape, an adhesive area 61 formed only in the middle section of the inner side of the tape strip 60 and coated with an adhesive, and a non-adhesive area 62 without any adhesive on two sides of the middle section of the inner side of the tape strip 60 respectively. The tape strip 60 is rolled around the outer periphery of the cylindrical body 50 to form a roll. In this design, after the tape strip 60 is pulled out and adhered to the package, only the adhesive area 61 of the tape strip 60 can be adhered to the package. When it is necessary to tear off the tape strip 60, any side of the non-adhesive area 62 can be used to conveniently tear off the tape strip 60 to achieve the purpose of opening the package or removing the tape strip 60. When this kind of tape strip 60 with an inner side of uneven thickness is rolled up onto the cylindrical body 50 to form a roll, the tape strip 60 usually deviates toward a side of the cylindrical body 50 as shown in FIG. 4. Therefore, this kind of easy-to-use hand-peeling tape cannot be cut by the tape dispenser during use, and users need to cut it by the cutter.

With reference to FIGS. 5 and 6 for another conventional easy-to-use hand-peeling tape without requiring the use of any tape dispenser or cutter, this tape includes a cylindrical body 70 and a tape strip 80, the tape strip 80 is made of a brittle material such as oriented polypropylene (OPP) and extended outward in a flat shape, and the inner side of the tape strip 80 is coated with an adhesive to form an adhesive area 81, and two long sides of the tape strip 80 have a plurality of tiny slots 82 (as shown in FIG. 6), so that when it is necessary to pull out the tape strip 80 to a desired length, the two long sides of the tape strip 80 can be used for tearing, and the slots 82 formed on the two long sides of the tape strip 80 in conjunction with the property of the brittle material can directly cut the tape strip 80. However, this kind of tape strip 80 can be cut at any position of the tape strip 80. As a result, its strength is relatively insufficient, the package adhered with the tape strip 80 may crack or break unexpectedly at any position of the tape strip 80, the protection strength is poor, and the section of the tape strip 80 torn off by hands will look uneven and ugly as shown in FIG. 6.

### SUMMARY OF THE DISCLOSURE

In view of the aforementioned shortcomings, the present disclosure provides a tape for sealing packages which includes a cylindrical body and a tape strip, and the tape strip includes a strip body, a release layer, an adhesive layer and two non-adhesive layers. The cylindrical body is in an annulus shape and has a predetermined width; the strip body is transparent and has an inner side and a relative outer side; the release layer is disposed on the outer side of the strip body; the adhesive layer is disposed in the middle section of the inner side; the two non-adhesive layers are disposed on two sides of the adhesive layer of the inner side respectively; the two non-adhesive layers and the adhesive layer so formed are coated with a glue degrader, such that two sides of the adhesive layer lose their adhesiveness to become the non-adhesive layers; the non-adhesive layers and the adhesive layer so formed having an equal thickness or a substantially equal thickness; the tape strip has a predetermined length and a segmented section in a non-cutting mode; and the tape strip is rolled up to the periphery of the cylindrical body to match a package.

The main objective of the present disclosure is to utilize the adhesive on the inner side of the tape strip in conjunction with the glue degrader in order to convert the adhesive layer into a non-adhesive layer without changing the thickness, and the segmented section in the non-cutting mode can limit the length of cutting the tape strip automatically without using the tape dispenser or cutter, and make the use more convenient and easier. In addition, the tape strip with the non-adhesive layer of a constant thickness can maintain the roll-up quality of the tape for sealing packages and make the tearing off of the tape strip by bare hands more easily.

### BRIEF DESCRIPTION OF THE DRAWINGS

FIG. 1 is a perspective view with a partial cross-sectional view of the conventional packaging tape;

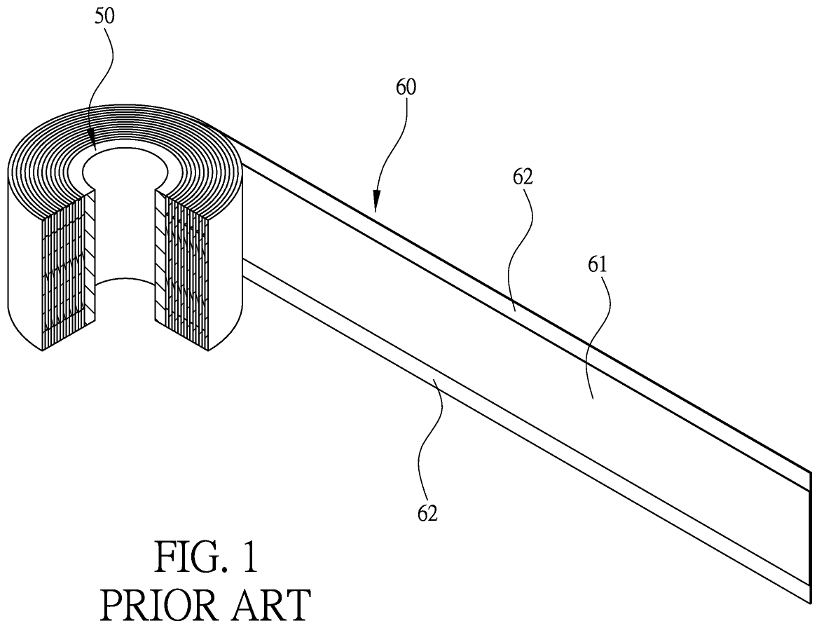

FIG. 2 is a partial cross-sectional enlarged view of the conventional packaging tape;

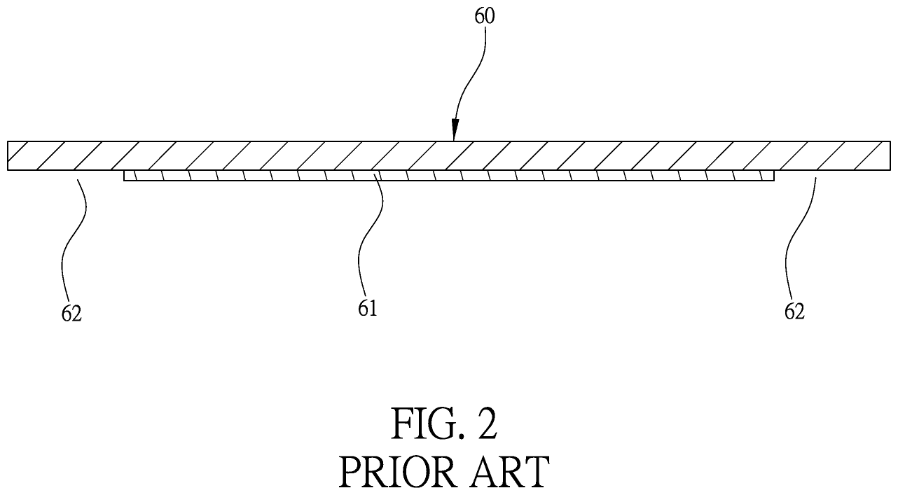

FIG. 3 is another partial cross-sectional enlarged view of the conventional packaging tape;

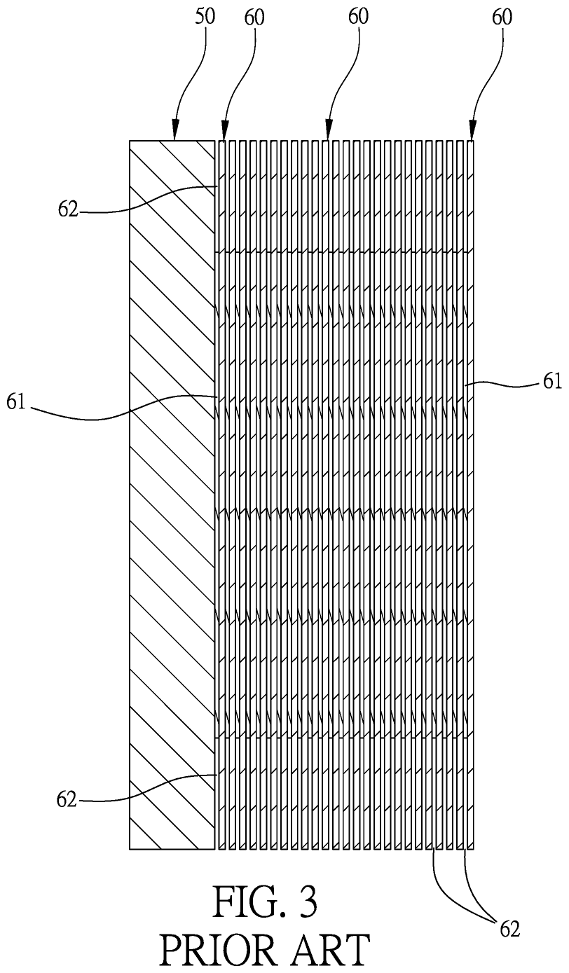

FIG. 4 shows a defective state of a related-art packaging tape of the conventional packaging tape when it is rolled up;

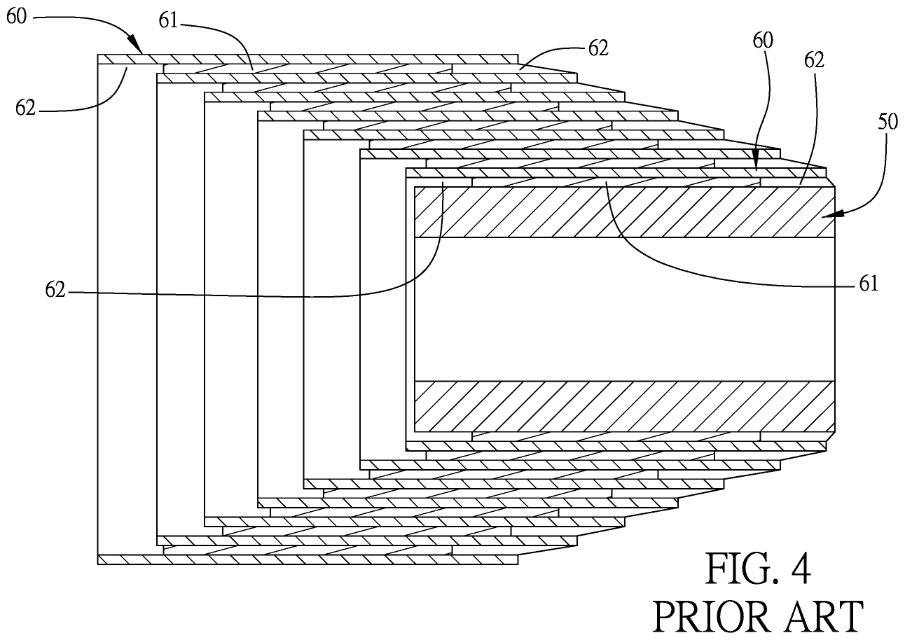

FIG. 5 is another perspective view of the conventional packaging tape;

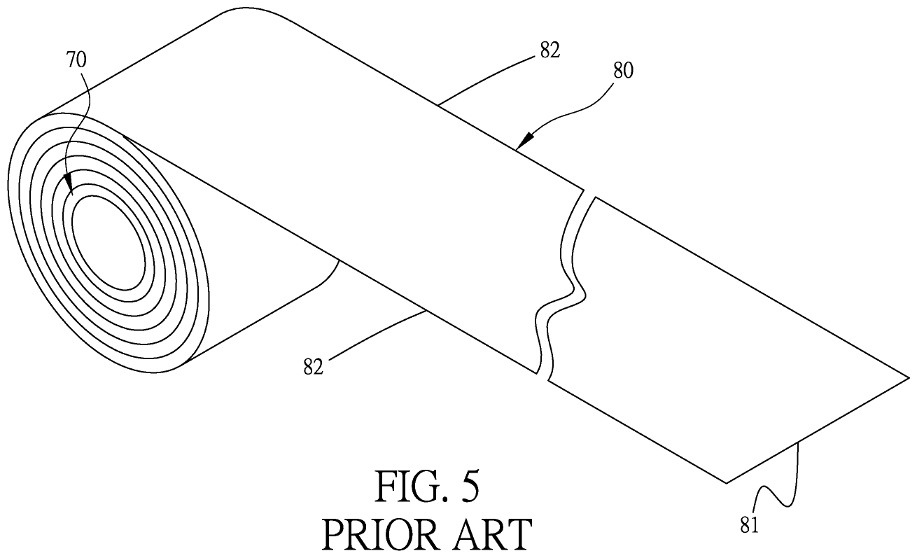

FIG. 6 is a schematic view of a tape strip torn off by the bare hands of the conventional packaging tape;

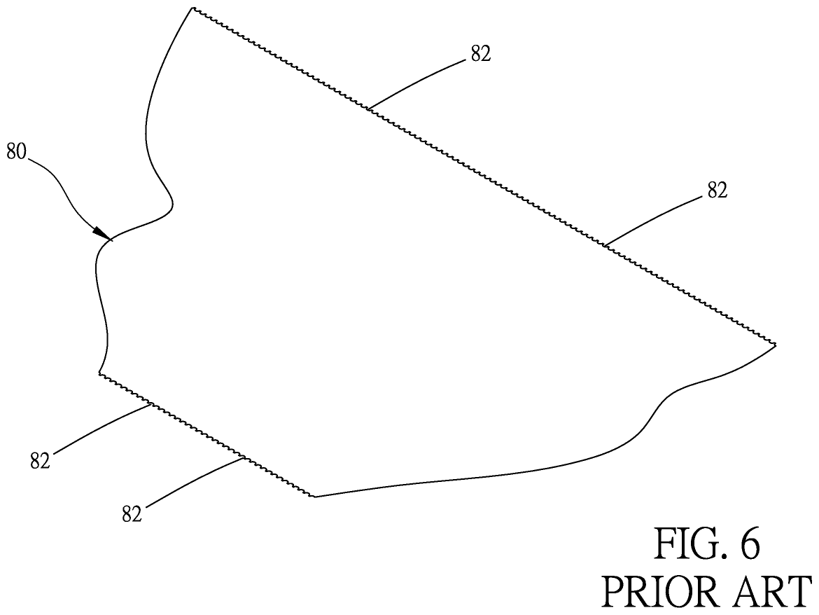

FIG. 7 is a perspective view with a partial cross-sectional view of a packaging tape of the present disclosure;

FIG. 8 is a perspective view of a packaging tape of the present disclosure that matches with a package;

FIG. 9 is a cross-sectional view of a tape strip of the present disclosure;

FIG. 10 is a partial cross-sectional enlarged view of a packaging tape of the present disclosure;

FIG. 11 is a schematic view showing the formation of an adhesive layer and a non-adhesive layer of a packaging tape of the present disclosure;

FIG. 12 is a perspective view of a packaging tape of the present disclosure that adheres and seals a package;

FIG. 13 is a cross-sectional view of a packaging tape of the present disclosure that adheres and seals a package; and

FIG. 14 is a perspective view of a packaging tape of the present disclosure that is peeled off from a package.

### DESCRIPTION OF THE PREFERRED EMBODIMENTS

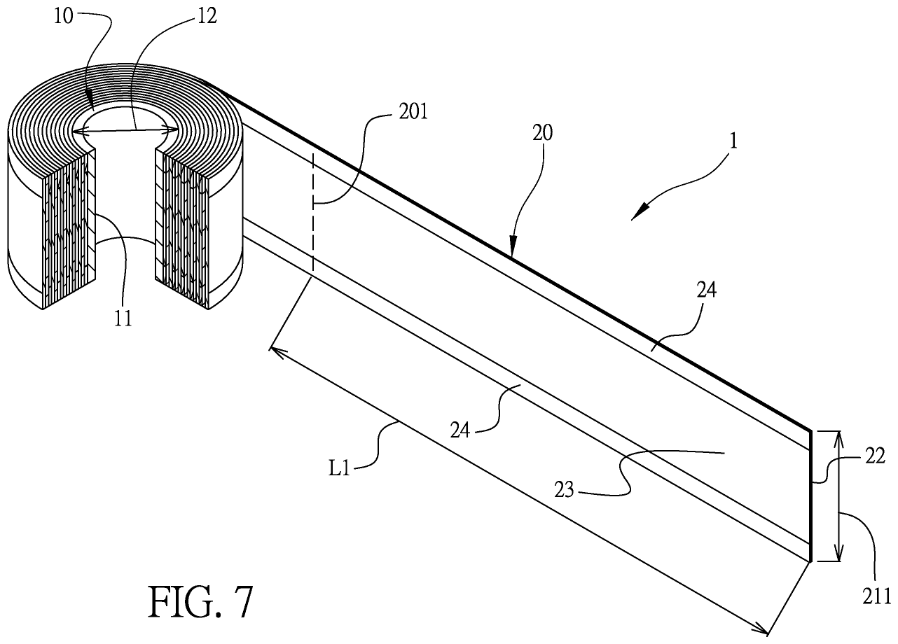

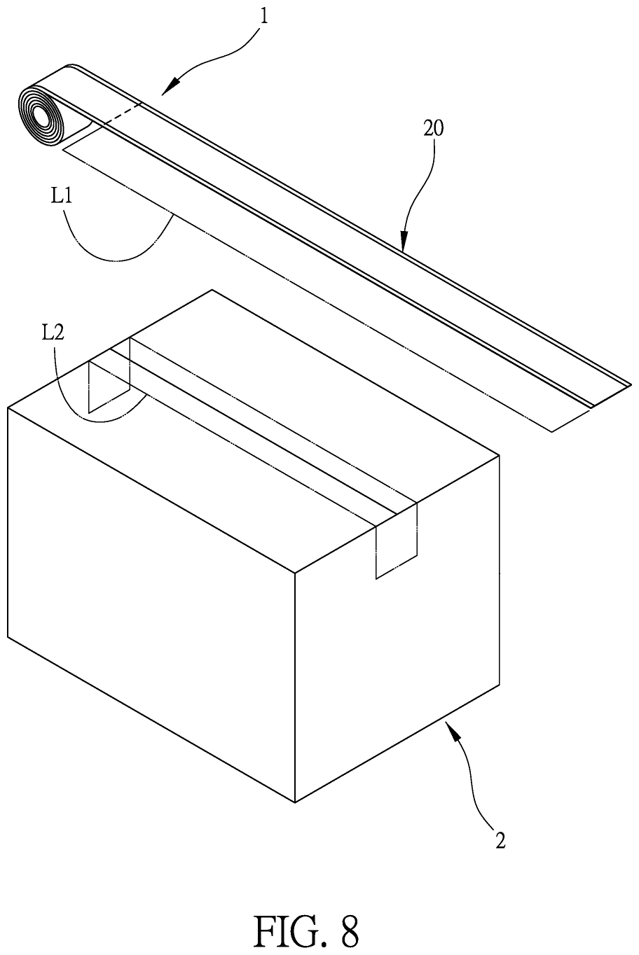

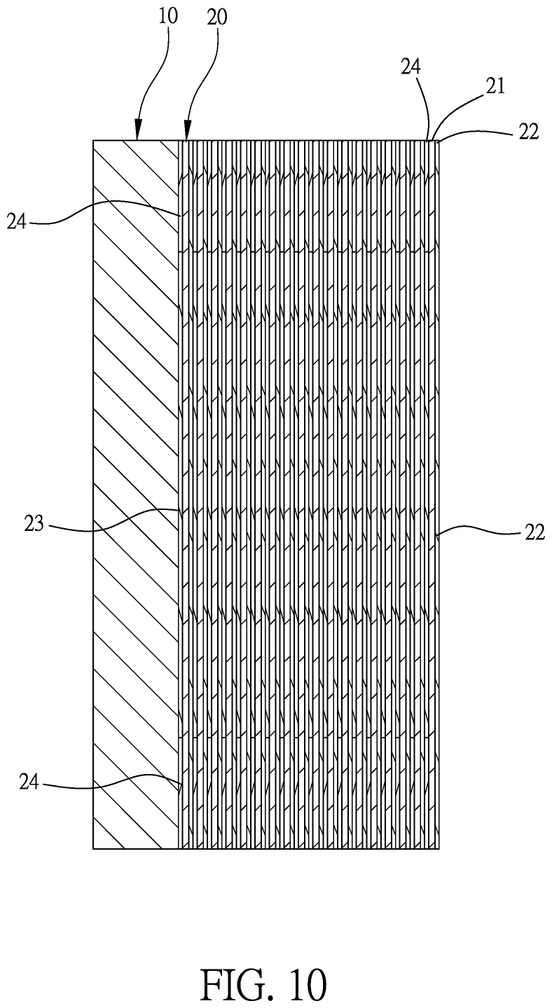

With reference to FIGS. 7 to 10 for a tape 1 for sealing packages in accordance with the present disclosure, the tape 1 for sealing packages includes a cylindrical body 10 and a tape strip 20, the tape strip 20 includes a strip body 21, a release layer 22, an adhesive layer 23 and two non-adhesive layers 24, and the tape 1 for sealing packages matches a package 2 (such as a carton) with a corresponding specification.

The cylindrical body 10 is in an annulus shape and has a predetermined width 11 and an outer diameter 12.

The strip body 21 is transparent and extended outward in a flat shape, and has a strip width 211 matched with the width 11 of the cylindrical body 10, an inner side 212, and an outer side 213 relative to the inner side 212.

The release layer 22 with an even and equal thickness is disposed on the outer side 213, the release layer 22 is provided for tearing off the adhesive object from the outer side 213 more easily, and the release layer 22 is transparent.

The adhesive layer 23 with an even and equal thickness is disposed in the middle section of the inner side 212 and has a color.

The two non-adhesive layers 24 with an even and equal thickness are disposed on two sides of the adhesive layer 23 of the inner side 212 respectively, and have a color, the adhesive layer 23 and the non-adhesive layer 24 are a combination of different colors or patterns, or transparency, or of any combination of colors.

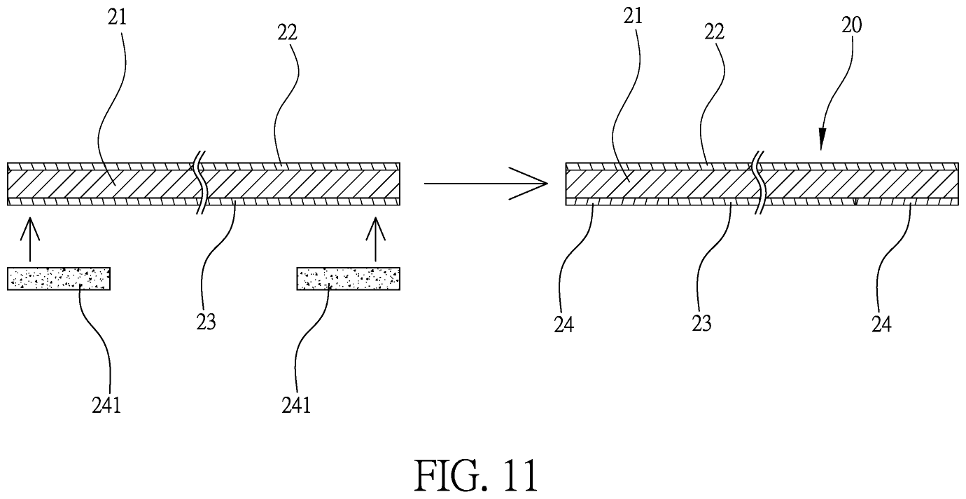

The adhesive layer 23 and the two non-adhesive layers 24 are simultaneously formed by an adhesive, the two non-adhesive layers 24 and the adhesive layer 23 so formed are coated with a glue degrader 241 or have a colored glue degrader 241, such that the glue degrader 241 is dissolved into the adhesive of the non-adhesive layer 24, or covered onto the adhesive surface in the manner of a thin film, and the two sides of the adhesive layer 23 lose their adhesiveness to become the non-adhesive layers 24 (as shown in FIG. 11), the non-adhesive layers 24 and the adhesive layer 23 so formed having an equal thickness or a substantially equal thickness, and the tape strip 20 has a predetermined length L1, and a segmented section 201 in a non-cutting mode arranged in every other predetermined length L1.

The tape strip 20 is rolled up by the adhesive layer 23 of the inner side 212 of the strip body 21 and adhered to the periphery of the cylindrical body 10. When the strip body 21 is rolled up for more than one round, the adhesive layer 23 of the inner side 212 is adhered to the release layer 22 of the outer side 213 of the previous round to spiral into a roll, so that the adhesive layer 23 for the next round can be adhered to the release layer 22, and the tape strip 20 can be torn off without being damaged.

The package 2 is designed to match the tape 1 for sealing packages, the package 2 has at least one opening intended to be sealed, and the opening of the package 2 has at least one longest package length L2 which is equal to the predetermined length L1 of the tape strip 20.

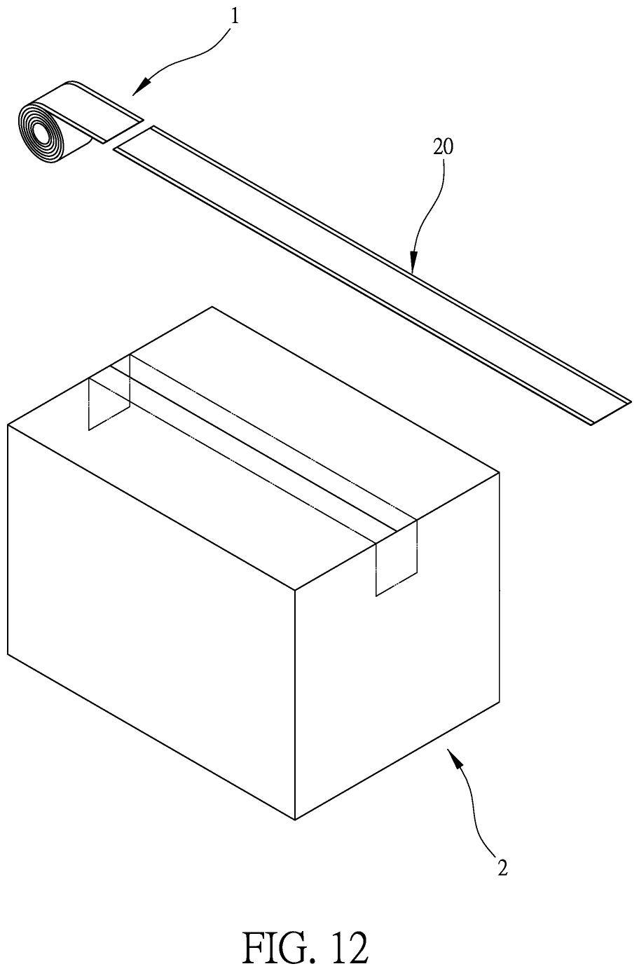

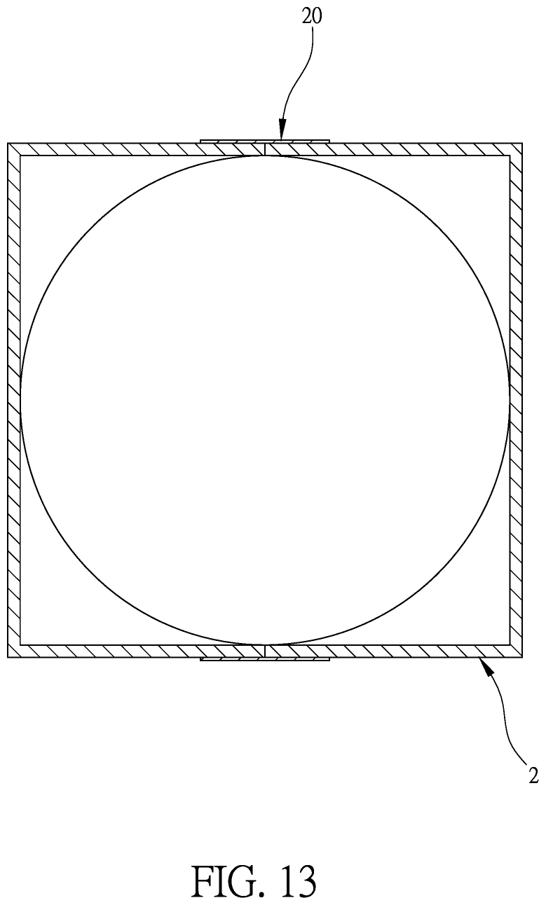

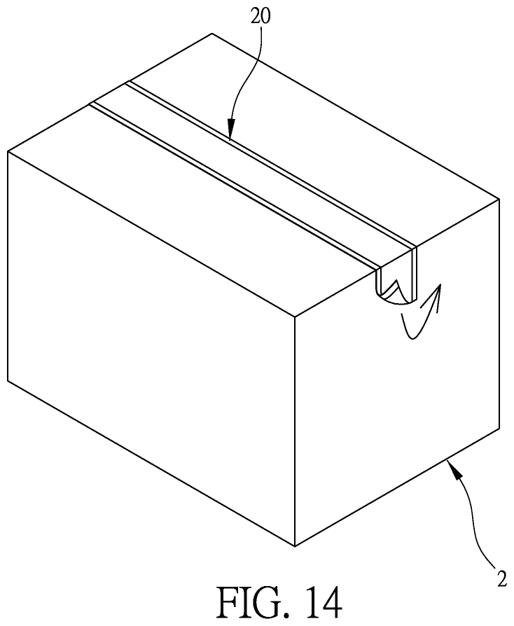

During use, as shown in FIG. 12, the non-adhesive layer 24 at an end of the tape 1 for sealing packages can be used to tear off and pull out the tape strip 20, and an end of the tape strip 20 corresponding to an end of the longest package length L2 of the package 2 is adhered and pulled out continuously. When the tape strip 20 is pulled to the segmented section 201 in the non-cutting mode, the segmented section 201 in the non-cutting mode may crack or break automatically, so that the predetermined length L1 can exactly seal the longest package length L2, and the adhesive layer 23 of the strip body 21 can seal the opening of the package 2 as shown in FIG. 13. To tear off the tape 1 for sealing packages of the package 2, it only needs to lift up the strip body 21 of the non-adhesive layer 24 in order to tear off the tape strip 20 from the package 2 as shown in FIG. 14.

With reference to FIGS. 7 to 10 for another tape 1 for sealing packages in accordance with the present disclosure, the tape 1 for sealing packages includes a cylindrical body 10 and a tape strip 20, the tape strip 20 includes a strip body 21, a release layer 22, an adhesive layer 23 and two non-adhesive layers 24, and the tape 1 for sealing packages matches a package 2 with a corresponding specification.

The cylindrical body 10 is in an annulus shape and has a predetermined width 11 and an outer diameter 12.

The strip body 21 is transparent and extended outward into a flat shape, and has a strip width 211 matched with the width 11 of the cylindrical body 10, an inner side 212, and an outer side 213 relative to the inner side 212.

The release layer 22 with an even and equal thickness is disposed on the outer side 213 and adhered to an adhesive object of the outer side 213 for easy tearing, and the release layer 22 is transparent.

The adhesive layer 23 with an even and equal thickness is disposed in the middle section of the inner side 212.

The two non-adhesive layers 24 with an even and equal thickness are disposed on two sides of the adhesive layer 23 of the inner side 212 respectively.

The adhesive layer 23 and the two non-adhesive layers 24 are simultaneously formed by an adhesive, the two non-adhesive layers 24 and the adhesive layer 23 so formed are coated with a glue degrader 241, such that both sides of the adhesive layer 23 lose their adhesiveness to form the non-adhesive layers 24, and the non-adhesive layer 24 and the adhesive layer 23 so formed having an equal thickness or a substantially equal thickness. In addition, the tape strip 20 has a predetermined length L1 and a segmented section 201 in a non-cutting mode disposed in every other predetermined length L1.

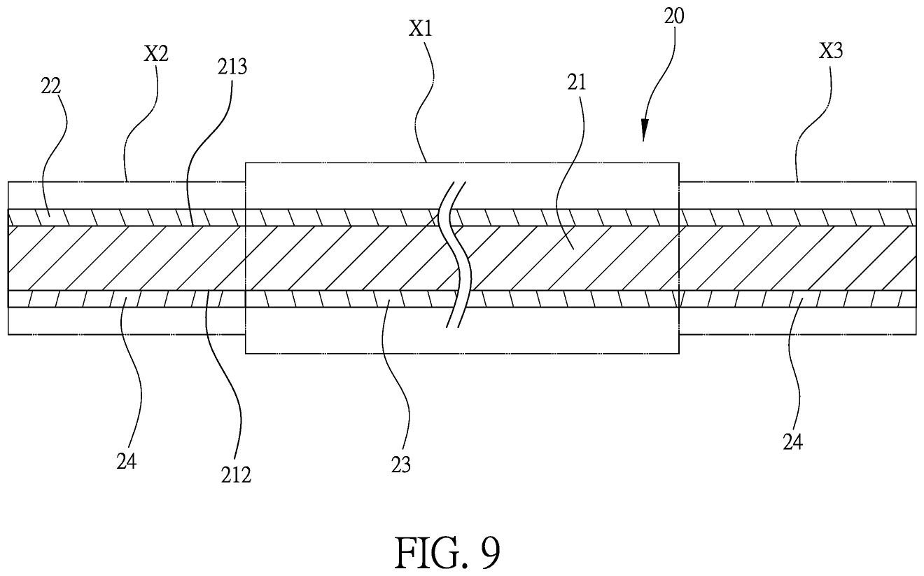

In FIG. 9, the tape strip 20 has a first interval X1 corresponding to the adhesive layer 23, a second interval X2 corresponding to one of the non-adhesive layers 24, and a third interval X3 corresponding to the other one of the non-adhesive layers 24. The first interval X1, the second interval X2 and the third interval X3 are of two or more combinations of colors, patterns or transparency, the first interval X1 and the second interval X2 and the third interval X3 must be of a combination of different colors or patterns or transparency, and the second interval X2 and the third interval X3 can be of a combination of same color, pattern or transparency or a combination of different colors, patterns or transparency. The color, pattern or transparency is designed for the release layer 22, the adhesive layer 23 or the non-adhesive layer 24.

The strip body 21 is rolled up by the adhesive layer 23 of the inner side 212 and adhered to the periphery of the cylindrical body 10 again. When the strip body 21 is rolled up for one round, the adhesive layer 23 of the inner side 212 is adhered to the release layer 22 of the outer side 213 of the previous round to spiral into a roll, such that the adhesive layer 23 for the next round can be adhered to the release layer 22 for tearing off without being damaged.

The package 2 is configured to match the tape 1 for sealing packages, the package 2 has at least one opening intended to be sealed, and the opening of the package 2 has at least one longest package length L2 which is equal to the predetermined length L1 of the tape strip 20.

What is claimed is:

1. A tape for sealing packages, comprising a cylindrical body and a tape strip, the tape strip comprising: a strip body, a release layer, an adhesive layer and two non-adhesive layers, and the tape for sealing packages matching a package with a corresponding specification;
the cylindrical body being in an annulus shape, and having a predetermined width;
the strip body being transparent, extending in a flat shape, having a strip width matching the width of the cylindrical body, an inner side, and an outer side relative to the inner side;
the release layer with even and equal thickness, disposed on the outer side of the strip body, and being in a transparent form;
the adhesive layer with even and having equal thickness, disposed on the middle section of the inner side;
the two non-adhesive layers with even and having equal thickness, disposed on two sides of the adhesive layer of the inner side respectively, and the adhesive layer and the non-adhesive layer being in different combinations of colors, or transparent, or in any combination of colors;
the adhesive layer and the two non-adhesive layers, simultaneously formed by an adhesive, the two non-adhesive layers and the adhesive layer so formed being coated with a glue degrader, such that two sides of the adhesive layer lose their adhesiveness to become the non-adhesive layer, and the non-adhesive layer and the adhesive layer so formed having equal thickness or substantially equal thickness;
the tape strip with a predetermined length, having a segmented section in every other predetermined length;
the tape strip, rolled up with the adhesive layer of the inner side of the strip body and adhered to the periphery of the cylindrical body, and the adhesive layer on the inner side after being rolled up for one round being adhered to the release layer on the outer side of the previous round to spiral into a roll; and
the package, configured to match the tape for sealing packages, and having at least one opening intended to be sealed, the opening of the package having at least one longest package length, which is equal to the predetermined length of the tape strip.

2. The tape for sealing packages according to claim 1, wherein the adhesive layer is colored or transparent, and the two non-adhesive layers are colored or transparent.

3. The tape for sealing packages according to claim 1, wherein the glue degrader is dissolved in the adhesive of the non-adhesive layer.

4. The tape for sealing packages according to claim 1, wherein the glue degrader covers the adhesive surface of the non-adhesive layer.

5. The tape for sealing packages according to claim 1, wherein the segmented section is in a non-cutting mode.

6. A tape for sealing packages, comprising a cylindrical body and a tape strip, the tape strip comprising a strip body, a release layer, an adhesive layer and two non-adhesive layers, and the tape for sealing packages matching a package with a corresponding specification;
the cylindrical body, being in an annulus shape, and having a predetermined width;
the strip body, being transparent and extending outward in a flat shape, and having a strip width matched with the width of the cylindrical body width, an inner side, and an outer side relative to the inner side;
the release layer with even and equal thickness, disposed on the outer side of the strip body, and the release layer being transparent;
the adhesive layer with even and equal thickness, disposed in the middle section of the inner side;
the two non-adhesive layers with even and equal thickness, disposed on two sides of the adhesive layer on the inner side respectively;
the adhesive layer and the two non-adhesive layers simultaneously formed by an adhesive, the two non-adhesive layers and the adhesive layer so formed being coated with a glue degrader, such that two sides of the adhesive layer lose their adhesiveness to become the non-adhesive layer, the non-adhesive layer and the adhesive layer so formed having an equal thickness or a substantially equal thickness;
the tape strip, having a predetermined length, and a segmented section in every other predetermined length;
the tape strip, rolled up by the adhesive layer of the inner side of the strip body and adhered to the periphery of the cylindrical body, and the adhesive layer on the inner side after being rolled up for one round being adhered to the release layer on the outer side of the previous round to spiral into a roll;
the package, matched with the configuration of the tape for sealing packages, and having at least one opening intended to be sealed, the opening of the package having at least one longest package length which is equal to the predetermined length of the tape strip; and
the tape strip, corresponding to the adhesive layer, having a first interval, the tape strip corresponding to one of the non-adhesive layers having a second interval, the tape strip corresponding to the other one of the non-adhesive layers having a third interval, the first interval, the second interval and the third interval having two or more different combinations of color, pattern, or transparency, the first interval and the second interval having a different combination of color, pattern or transparency, and the first interval and the third interval having a different combination of color, pattern or transparency.

7. The tape for sealing packages according to claim 6, wherein the color, pattern or transparency is designed for the release layer.

8. The tape for sealing packages according to claim 6, wherein the color, pattern or transparency is designed for the adhesive layer.

9. The tape for sealing packages according to claim 6, wherein the color, pattern or transparency is designed for the non-adhesive layer.

10. The tape for sealing packages according to claim 6, wherein the glue degrader is dissolved in the adhesive of the non-adhesive layer.

11. The tape for sealing packages according to claim 6, wherein the glue degrader covers the adhesive surface of the non-adhesive layer.

12. The tape for sealing packages according to claim 6, wherein the second interval and the third interval come with the same combination of colors or patterns or transparency.

13. The tape for sealing packages according to claim 6, wherein the segmented section is in a non-cutting mode.

14. A tape for sealing packages, comprising a cylindrical body and a tape strip, the tape strip comprising a strip body, a release layer, an adhesive layer and two non-adhesive layers;
the cylindrical body, being in an annulus shape, and having a predetermined width;
the strip body, being transparent and extending outward in a flat shape, and having a strip width matched with the width of the cylindrical body width, an inner side, and an outer side relative to the inner side;
the release layer with even and equal thickness, disposed on the outer side of the strip body, and the release layer being transparent;
the adhesive layer with even and equal thickness, disposed in the middle section of the inner side;
the two non-adhesive layers with even and equal thickness disposed on two sides of the adhesive layer on the inner side respectively;
the adhesive layer and the two non-adhesive layers simultaneously formed by an adhesive, the two non-adhesive layers and the adhesive layer so formed being coated with a glue degrader, such that two sides of the adhesive layer lose their adhesiveness to become the non-adhesive layer, the non-adhesive layer and the adhesive layer so formed having equal thickness or substantially equal thickness;
the tape strip, having a predetermined length, and a segmented section in every other predetermined length;
the tape strip, rolled up by the adhesive layer of the inner side of the strip body and adhered to the periphery of the cylindrical body, and the adhesive layer on the inner side after being rolled up for one round being adhered to the release layer on the outer side of the previous round to spiral into a roll; and
the tape strip, corresponding to the adhesive layer, having a first interval, the tape strip corresponding to one of the non-adhesive layers having a second interval, the tape strip corresponding to the other one of the non-adhesive layers having a third interval, the first interval, the second interval and the third interval having two or more different combinations of color, pattern, or transparency, the first interval and the second interval having a different combination of color, pattern or transparency, and the first interval and the third interval having a different combination of color, pattern or transparency.

15. The tape for sealing packages according to claim 14, wherein the color, pattern or transparency is designed for the release layer.

16. The tape for sealing packages according to claim 14, wherein the color, pattern or transparency is designed for the adhesive layer.

17. The tape for sealing packages according to claim 14, wherein the color, pattern or transparency is designed for the non-adhesive layer.

18. The tape for sealing packages according to claim 14, wherein the glue degrader is dissolved in the adhesive of the non-adhesive layer.

19. The tape for sealing packages according to claim 14, wherein the glue degrader covers the adhesive surface of the non-adhesive layer.

20. The tape for sealing packages according to claim 14, wherein the second interval and the third interval come with the same combination of colors or patterns or transparency.
